(19) United States
(12) Patent Application Publication
(10) Pub. No.: US 2004/0155096 A1
(43) Pub. Date: Aug. 12, 2004

(54) Diamond tool inserts pre-fixed with braze alloys and methods to manufacture thereof

(75) Inventors: Michael H. Zimmerman, Westerville, OH (US); Dwight E. Dyer, Kingston, OH (US); James Michael McHale JR., Worthington, OH (US); Scott Arlen Ries, Grove City, OH (US); James D. Graham, Gahanna, OH (US); York Falkenberg, Roedermark (DE); Dirk Heinemann, Bad Homburg (DE)

Correspondence Address: Hanh T. Pham, GE Plastics - 130335-2 60SD, One Plastics Avenue, Pittsfield, MA, 01201, US

(73) Assignee: General Electric Company

(21) Appl. No.: 10/744,688

(22) Filed: Dec. 23, 2003

Related U.S. Application Data
(60) Provisional application No. 60/445,613, filed on Feb. 7, 2003.

(51) Int. Cl. B23K 31/00

(52) U.S. Cl. 228/248.1

(57) ABSTRACT

A superabrasive tool blank whose carbide side is affixed with a suitable braze alloy, for subsequent shaping into desired tool geometry and induction-brazed forming a cutting tool. The use of the pre-coated braze alloy in the tool blank forming cutting tools allows the direct brazing of the superabrasive blank onto a tool insert, thus minimizing operations and labor time involved for the shaping and handling of the braze substrate in the process of the prior art, i.e., the brazing of the assembly of the superabrasive tool blank, braze alloy, and tool insert. The pre-brazed blank can be conveniently used in automated brazing operations for forming cutting tools.

### CROSS-REFERENCE TO RELATED APPLICATIONS

This patent application claims priority to U.S. Provisional Application No. 60/445,613 with a filing date of Feb. 7, 2003.

### FIELD OF THE INVENTION

The present invention relates to diamond tool blanks pre-coated with a braze alloy and methods to manufacture such tool blanks thereof.

### BACKGROUND OF THE INVENTION

Cutting tools for machining, milling, turning, cutting, or drilling are often provided with inserts of hard cutting materials, e.g., superabrasives materials. Polycrystalline diamond (“PCD”) and cubic boron nitride (“PCBN”) are superabrasive materials widely used in tool inserts for machining or cutting non-ferrous and ferrous materials, respectively. The tools are typically made by brazing the PCD/PCBN blanks to a tool insert or tool body, e.g., steel shanks, then grinded or shaped into its final configuration with diamond wheels.

Tools made with PCD or PCBN blanks typically outperform many ordinary tools in production applications. However, the process of fabricating a cutting tool from PCD or PCBN blanks is a labor-intensive process, particularly in the brazing operation to join or bond the superabrasive blank and the tool insert by a fusion process. Bond strength is a function of various factors, including the clearance between the parts, the brazing material used, the joint interface, and the brazing conditions. In the brazing operation, care is taken to assure good bonding at the interface of the superabrasive blank and the tool. The braze material is applied or placed onto the joint surface prior to heating. The braze material can be in one of many forms, slurry, paste, powder, preformed ring, washers, disks, tapes, or foil, which is fitted into internal grooves or pockets of the meeting carbide surfaces.

Braze material in the form of an alloy foil is typically favored over other forms for a number of reasons, including but not limited to the superior flow characteristics which facilitate good bonding (see “Brazing with amorphous foil performs” June 2001 of Advanced Materials & Processes”). However, the use of braze foil significantly increases the cost of tool making, due to the additional labor required for the tedious cutting of pieces of braze alloy foil in shapes to match the cut tool blank, as well as the delicate handling and precise positioning required for these small foil and tool blank pieces.

In the brazing process, a braze material is placed between the tool blank and the tool insert (or other tools onto which the blank is to be brazed), a flux material is applied to prevent oxidation, and the assembly is heated to a temperature above the liquidous of the braze material. The heating process is also labor intensive because the operator has to pay close attention to the joint interface, i.e., the tool insert, the braze interface layer and the tool blank, and reposition the materials as necessary to assure good bonding between the surfaces. When the tool blank is correctly positioned in the pocket and the braze sufficiently spread throughout the interface, the assembly is cooled to room temperature to complete the brazing operation. In the final step, the edges of the assembly are then finish-ground to the desired tool geometry.

As indicated by Carb-I-Tool, a leading manufacturer of precision 1 workshop routing, shaping and cutting tools: “One of the keys to a quality bit is a perfect braze free of air bubbles to seal the carbide tip to the body. Skilled operators are still the best way to ensure [a quality bit]” (http://www.aptoolparts.com/html/about_us.html).

Applicants have found a method to minimize or do away with some of the time-consuming steps in prior art processes, requiring skilled operators for the tedious shaping/cutting and handling of the braze substrate, prior to and during the brazing operation fusing the superabrasive tool blank with the tool insert. In the method of the present invention, part of the brazing process is done “off-line,” i.e., the tool blank is prefixed with braze alloys.

### SUMMARY OF THE INVENTION

The present invention relates to superabrasive tool blanks whose carbide side is coated with a suitable braze alloy, for subsequent shaping into desired tool geometry and induction-brazed forming a cutting tool.

The invention also relates to a process to form a cutting tool, comprising the steps of coating the carbide side of a supported superabrasive tool blank with a suitable braze alloy, optionally cutting or shaping said braze alloy coated tool blank into desired shape or precise dimensions, and brazing the braze alloy coated tool blank into a pocketed tool insert or tool body.

### BRIEF DESCRIPTION OF THE DRAWINGS

FIG. 1 is a photograph showing an EDM cut edge of an embodiment of a blank of the present invention, after being coated with a braze alloy.

FIG. 2 is a photograph of an embodiment of a braze-coated PCD blank of the present invention, after brazing into a tool body.

FIG. 3 illustrates the use of the braze-coated blanks of the present invention in an automated brazing process, as part of a feed tray into a brazing operation.

### DETAILED DESCRIPTION OF THE INVENTION

As described in the sections that follow, the carbide side of a supported superabrasive tool blank is pre-coated or prefixed with a suitable braze alloy prior to the tool blank being brazed directly onto a tool insert or body. The prefixed or pre-coated braze alloy on the carbide side of the tool blank eliminates the handling of the braze alloy interface in a brazing process. In the process of the invention, a superabrasive tool blank is pre-fixed with a suitable braze alloy, and the braze-alloy-coated tool blank is then brazed into a pocketed tool insert or tool body.

Providing a Superabrasive Tool Blank. As used herein, “superabrasive tool blank” refers to a component of a compact of PCD (Polycrystalline Diamond) or PCBN (polycrystalline cubic boron nitride) bonded to a support of cemented metal carbide.

A compact may be characterized generally as an integrally bonded structure formed of a sintered, polycrystalline mass of abrasive particles, such as diamond or cubic boron nitride (CBN). The compact may be sell-bonded, or may include a suitable bonding matrix of about 5% to 75% by volume. The bonding matrix usually is a metal such as cobalt, iron, nickel, platinum, titanium, chromium, tantalum, copper, or an alloy or mixture thereof, or ceramic materials such as nitrides, carbides, borides, and oxides of transition metals or mixtures thereof. The matrix additionally may contain recrystallization or growth catalyst such as aluminum for CBN or cobalt for diamond.

The support cemented metal carbide comprises tungsten, titanium, or tantalum carbide particles, or a mixture thereof, which are bonded together with a binder of between about 6% to about 25% by weight of a metal such as cobalt, nickel, or iron, or a mixture or alloy thereof.

The process to form the superabrasive tool blanks is done via a high pressure/high temperature (HP/HT) method. The process involves placing an unsintered mass of abrasive, crystalline particles, such as diamond or CBN, or a mixture thereof, within a protectively shielded enclosure disposed within the reaction cell of an HP/HT apparatus. Additionally placed in the enclosure with the abrasive particles may be a metal catalyst if the sintering of diamond particles is contemplated, as well as a pre-formed mass of a cemented metal carbide for supporting the abrasive particles and thus forming the support for the compact. The contents of the cell then are subjected to processing conditions sufficient to effect intercrystalline bonding between adjacent grains of abrasive particles and, optionally, the joining of sintered particles to the cemented metal carbide support. Such HP/HT processing conditions generally involve the imposition for about 3 to 120 minutes of a temperature of at least 1000° C. and a pressure of at least 20 Kbar.

Superabrasive blanks are commercially available from General Electric Company under the trade names COMPAX, BZN, and Stratapax. In one embodiment, the carbide supported tool blanks are in the form of discs ranging from about 10 mm to 74 mm in diameter.

Prefixing the Superabrasive Tool Blank with Braze Alloy. In one embodiment of the present invention, the tool blank is pre-coated or pre-fixed with a braze alloy prior to being formed or shaped into desired geometry.

A variety of braze alloy compositions may be used for the present invention, e.g., the braze alloy compositions as described in the Kirk-Othmer Encyclopedia of Chemical Technology, 3rd Edition, Vol. 21, pages 342 et seq. The braze alloy composition may also contain silicon and/or boron, which serve as melting point suppressants.

In one embodiment, the braze alloy contains precious metals such as silver, gold, and/or palladium, in combination with other metals, such as copper, manganese, nickel, chrome, silicon, and boron. In another embodiment, the braze alloy comprises about 78 to about 99.97% by weight of the first metal, e.g. silver; about 0.01 to about 12% by weight of a second metal, e.g. copper; about 0.01 to about 5% by weight of a third metal, e.g. nickel; and about 0 to about 5% by weight silicon, all based on the total weight of the braze alloy. In yet another embodiment, the braze alloy has a composition of 78-99.97% silver, 0.01-12% copper, 0.01-5% nickel and, optionally, 0.01-5.0% silicon.

The braze alloy can be applied in various forms, including but not limited to: a) a foil form as commercially available from various sources including Wesgo, Allied Signal, and Vitta in thicknesses ranging from 0.0005 to 0.003 inches or more; b) a wire form; c) powders; d) a paste; and e) a slurry containing a metal powder, a binder such as polyethylene oxide and various acrylics, or solvent-based binders, and optionally, a solvent.

Various techniques for applying or affixing the braze alloy onto the carbide side of the supported superabrasive tool blank include but are not limited to: a) melt coating, i.e. applying the braze alloy in its liquid form and solidifying in place as a uniform layer; b) electroless plating; c) electroplating; d) sputter coating or other physical deposition methods; e) chemical vapor deposition methods; t) laser, tack-welding, or spot welding of the braze alloy in the form of a braze foil; g) brushing or applying as a paint or paste with a suitable binder material; h) affixing the braze alloy in a foil form with a suitable binder or adhesive tapes well-known in the art and commercially available from sources such as Sulzer-METCO, Inc.; i) flame spraying; j) hot pressing or hot rolling; k) cold pressing or cold rolling; and l) tinning or dip coating in the molten braze alloy.

In one embodiment, a sufficient amount of braze alloy is applied or affixed onto the carbide side of the superabrasive blank to ensure good bonding between the blank and the tool insert in a brazing operation. In another embodiment, the thickness of the braze alloy applied is that of the composite foil brazing material used, e.g., about 30 to 150 μm.

Forming desired tool blank shape. After the braze alloy is applied onto the superabrasive blank, the braze alloy-coated blank may optionally be machined into the final desired shape, e.g., an 80° triangle with 5.0 mm edge length, etc. for subsequent placing onto the pocketed insert or tool body.

The forming can be done via any of the processes known in the art including Electro Discharge Machining (EDM), Electro Discharge Grinding (EDG), laser, plasma, and water jet. In one embodiment, the blank prefixed with braze alloys is formed into shape via means of an abrasive water jet. In another embodiment, the surface of the blank is laser-etched at selected positions on the surface or according to a predetermined computer controlled pattern for a final desired shape

Brazing into Tool Insert. As used herein, “tool insert” or simply “tool” is used to refer to the tool body, tool block, or other tool into which the superabrasive blank is to be brazed. Each tool insert may optionally contain a pocket for receiving the pre-brazed superabrasive blank. In the final step of the invention, the shaped blank is brazed directly into the pocketed tool insert, e.g., steel shank.

The brazing can be done by any brazing means in the art including dip brazing, furnace brazing, brazing by torch heating, brazing by induction heating, and brazing by resistance heating. Brazing temperature depends in part on the type of braze alloy used, and are typically in the range of about 525° C. to about 1650° C.

In one embodiment of the invention, brazing is done via induction heating for rapid heating (depending on the size of the tool, it can be just a few seconds for a complete cycle), uniform results, and localized heating in the joint surface with the use of induction coils.

In the final step of brazing the blank prefixed with braze alloy into the pocketed insert or tool, a brazing flux may be used to dissolve oxides that may form on the surfaces. The flux may be in the form of a paste or powder.

It should be noted that with the use of pre-coated or pre-fixed braze alloy on the carbide support of the superabrasive blank, much less flux is needed in the process of brazing the blank into the tool insert or body. Additionally, having the braze alloy prefixed to the superabrasive tool blank will also greatly simplify the brazing process, as it eliminates the need for handling and correctly positioning small pieces of braze foil.

Using Prefixed Braze Alloy Superabrasive Blanks in Automatic Brazing Operations. Applicants have found that the use of superabrasive tool blanks with prefixed braze alloys greatly facilitates automated brazing operations, i.e., the use of braze fixtures to braze the tool blanks and the tool body or insert with little or minimal operator interventions. In one embodiment of the invention, the pre-brazed superabrasive tool blanks are used in an operation employing an automatic brazing machine along the line of the apparatus disclosed in U.S. Pat. No. 5,125,555, “Automatic braze welding machine with sensor,” wherein the brazing means is via flame heating.

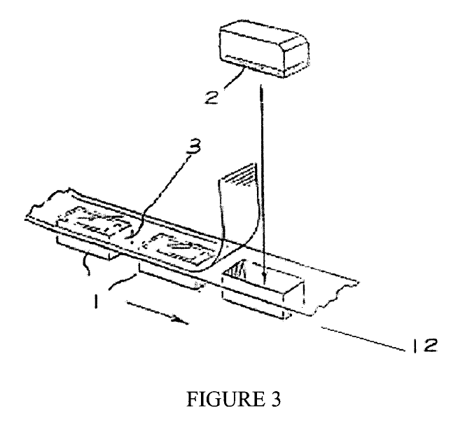

In another embodiment of an automated process employing the prefixed braze alloy blanks of the present invention, the braze-coated blanks 2 after being cut/shaped into a desired geometry (e.g., triangles, blocks, etc.) are loaded onto a tray 12 having multiple pockets 1 as shown in FIG. 3. Pocketed carbide inserts are loaded onto another tray 20 also having multiple pockets, and the tray 20 with inserts is also loaded into the brazing machine. The trays 12 and 20 may be loaded onto a spindle or placed into a conveyor system for automatic and continuous feeding into the brazing machine, with the trays moving forward one pocket of a time to feed a braze-coated blank and a corresponding carbide insert onto an inductively heated block.

As the trays move forward one pocket at a time, an optional cover tape 3 is simultaneously peeled back from the pockets, exposing a braze-coated blank 2 or corresponding inserts. In the brazing process, a turning arm conveyor, a robotic arm, or similar mechanical means located downstream arranged to precisely place the pocketed carbide insert onto an inductively heated block. The turning arm (or a second turning arm) takes the braze-coated blank 2 and places it in pocket 1 of the heated insert. Inductive heating is automatically reduced after a pre-set time, i.e., after the braze alloy melts, and the finished/brazed insert is automatically removed by the turning arm and the process is repeated until all of the tool inserts are brazed.

In one embodiment of the automated brazing process of the present invention with pre-brazed blanks (or prefixed, or pre-coated with braze alloy blanks), there is no need to manually apply a braze alloy foil or paste into each pocketed insert prior to brazing, or the need to manually assemble and load the whole sandwich assembly of insert-braze-blank onto a brazing machine. It should also be noted that there is no need for the manual cutting of braze foil to shape to carefully match the interface surface to be brazed.

### EXAMPLE

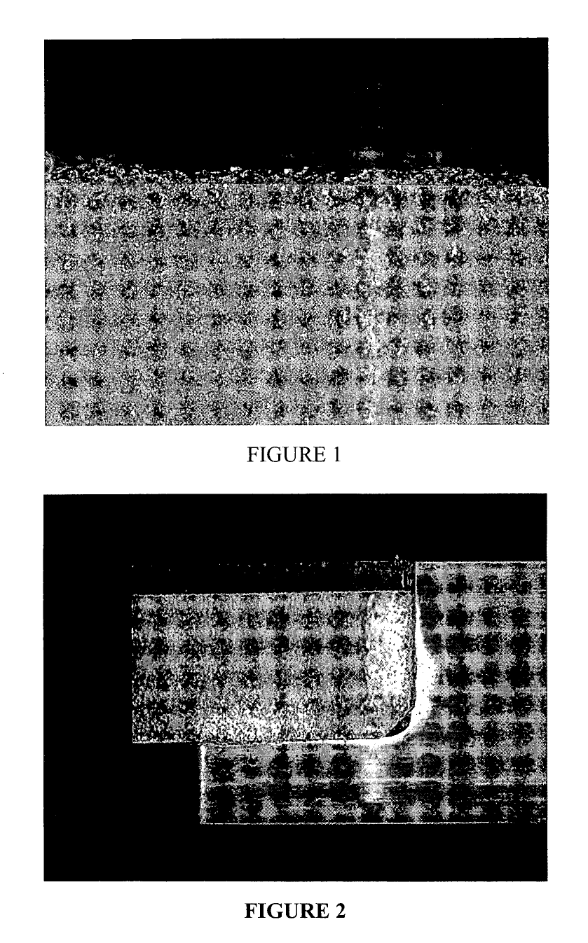

The examples below and as generally illustrated by FIGS. 1 and 2 are merely representative of the work that contributes to the teaching of the present invention, and the present invention is not to be restricted by the examples that follow.

### Example 1

In this example, a 58 mm diameter, carbide supported polycrystalline diamond (“PCD”) tool blank is used. The tool blank is available from GE Superabrasives, Inc. of Worthington, Ohio as GE Compax 1500. The tungsten carbide side of the PCD blank is cleaned by garnet grit blasting and rinsing with isopropanol. A standard braze alloy foil (49% Ag, 16% Cu, 23% Zn, 7.5% Mn, 4.5% Ni) is cut into a 58 mm diameter disc and placed on top of the carbide surface of the PCD blank. This assembly is next coated with a suitable flux material to prevent oxidation and inductively heated to above the melting point of the alloy (˜650° C.). When the braze alloy is sufficiently liquefied, the inductive heating is stopped and the blank allowed to cool to room temperature. The braze alloy is well bonded to the carbide surface on solidification. The braze coated tool is then cleaned by garnet grit blasting, and several tool blank shapes are cut from the blank by wire EDM.

FIG. 1 shows a cross section of the braze coated tool blank of Example 1. As seen in the figure, the alloy layer uniformly covers the carbide surface and the interface appears to be well-bonded and continuous.

### Example 2

In this example, the braze alloy coated compact of Example 1 is inducted brazed in air to form a complete cutting tool. It is noted that the coated alloy readily wets the carbide support, providing a high strength cutting tool tip suitable for use. It is further noted that the brazing process being much simpler and faster than expected as in the prior art process, i.e., a brazing process wherein a braze alloy substrate is used as an interface material.

FIG. 2 is a photograph of the tool of Example 2, i.e., the braze-coated PCD blank after brazing into a tool. As seen in the figure, the braze alloy layer uniformly covers the carbide surfaces thus assures excellent bonding.

### Example 3

The same type of braze foil and PCD disc as in Example 1 are mechanically joined by a cold pressing technique. To facilitate mechanical attachment of the braze foil, a crosshatch pattern is formed on the carbide surface of the PCD blank by wire electro-discharge machining (EDM). The crosshatch pattern is formed by machining two perpendicular sets of lines in the carbide surface. Each line in a set has a depth of 0.010″ and a width of 0.030″. These lines are spaced parallel to each other at a center to center distance of 0.035″ apart. The second set of lines is formed by rotating the PCD blank by 90 degrees with respect to the wire EDM and repeating the same pattern.

A standard braze alloy foil (49% Ag, 16% Cu, 23% Zn, 7.5% Mn, 4.5% Ni) with 0.005″ thickness is then cut into a 58 mm diameter disc and placed on top of the carbide surface of the PCD blank. The foil is then pressed onto the carbide surface with a Carver laboratory press using a pressing force of 10,000 lbs After pressing, the foil is deformed into the grooves in the crosshatch pattern and thus mechanically attached to the PCD blank. As expected, the braze-coated PCD blank of Example 3 also readily provides a high-strength cutting tip that facilitates the brazing process

While the invention has been described with reference to a preferred embodiment, those skilled in the art will understand that various changes may be made and equivalents may be substituted for elements thereof without departing from the scope of the invention. All citations referred herein are expressly incorporated herein by reference.

1. A blank for use in a tool insert, comprising a polycrystalline compact bonded to a cemented carbide support, wherein said cemented carbide support is affixed with a brazing alloy.

2. The blank of claim 1, wherein said polycrystalline compact comprises hard sintered bodies containing cubic boron nitride, diamond, or mixtures thereof.

3. The blank of claim 1, wherein said cemented carbide support is affixed with the brazing alloy by a technique selected from one of:
a) melt coating said brazing alloy onto said carbide support;
b) electroless plating said brazing alloy onto said carbide support;
c) electroplating said brazing alloy onto said carbide support;
d) sputter coating said brazing alloy onto said carbide support;
e) physical vapor depositing said brazing alloy onto said carbide support;
f) chemical vapor depositing said brazing alloy onto said carbide support;
g) spot welding said braze alloy as a braze foil onto said carbide support;
h) brushing said brazing alloy as a paint or paste with a suitable binder material onto said carbide support;
i) adhering said braze alloy in a foil form with an adhesive onto said carbide support;
j) flame spraying said brazing alloy onto said carbide support;
k) hot pressing said braze alloy as a braze foil onto said carbide support;
l) cold pressing said braze alloy as a braze foil onto said carbide support; and
m) dip coating said carbide support in said braze alloy in a molten form.

4. The superabrasive blank of claim 1, wherein said cemented carbide support is affixed with the brazing alloy by coating said cemented carbide support with an alloy composition comprising about 78-99.97% silver, 0.01-12% copper, 0.01-5% nickel and, optionally, 0.01-5.0% silicon.

5. The superabrasive blank of claim 1, wherein said cemented carbide support is affixed with a brazing alloy in a form of a slurry, paste, powder, ring, washer, disk, tape, or foil.

6. The superabrasives blank of claim 5, wherein said brazing alloy is a foil having a thickness ranging from 0.0005 to 0.003 inches.

7. A blank for use in a tool insert, said blank comprising a polycrystalline compact bonded to a cemented carbide support affixed with a brazing alloy, and wherein the carbide support affixed with the brazing alloy of said blank is directly brazed onto the tool insert in a brazing process.

8. The blank of claim 7, wherein said cemented carbide support is affixed with the brazing alloy by a technique selected from one of:
a) melt coating said brazing alloy onto said carbide support;
b) electroless plating said brazing alloy onto said carbide support;
c) electroplating said brazing alloy onto said carbide support;
d) sputter coating said brazing alloy onto said carbide support;
e) physical vapor depositing said brazing alloy onto said carbide support;
f) chemical vapor depositing said brazing alloy onto said carbide support;
g) spot welding said braze alloy as a braze foil onto said carbide support;
h) brushing said brazing alloy as a paint or paste with a suitable binder material onto said carbide support;
i) adhering said braze alloy in a foil form with an adhesive onto said carbide support;
j) flame spraying said brazing alloy onto said carbide support;
k) hot pressing said braze alloy as a braze foil onto said carbide support;
l) cold pressing said braze alloy as a braze foil onto said carbide support; and
m) dip coating said carbide support in said braze alloy in a molten form.

9. The blank of claim 7, wherein said cemented carbide Support is affixed with the brazing alloy by coating said cemented carbide support with a brazing composition comprising 78-99.97% silver, 0.01-12% copper, 0.01-5% nickel and, optionally, 0.01-5.0% silicon.

10. The blank of claim 9, wherein said cemented carbide support is affixed with a brazing alloy in a form of a slurry, paste, powder, ring, washer, disk, tape, or foil

11. The blank of claim 10, wherein said brazing alloy is a foil having a thickness ranging from 0.0005 to 0.003 inches.

12. A method to fabricate a cutting tool, said method comprises the steps of brazing a blank comprising a polycrystalline compact bonded to a cemented carbide support affixed with a brazing alloy into a tool insert.

13. The method of claim 12, further comprises the step of configuring said blank into a geometry allowing correct positioning of said blank into said tool insert prior to brazing said blank into said tool insert.

14. The method of claim 13, wherein said configuring of said blank is via one of electro discharge machining, electro discharge grinding, laser, plasma, water jet, and combinations thereof.

15. A cutting tool comprising a tool insert and a blank, wherein said blank comprises a polycrystalline compact bonded to a cemented carbide support affixed with a brazing alloy.

16. The cutting tool of claim 15, wherein said cemented carbide support is affixed with the brazing alloy by a technique selected from one of:
a) melt coating said brazing alloy onto said carbide support;
b) electroless plating said brazing alloy onto said carbide support;
c) electroplating said brazing alloy onto said carbide support;
d) sputter coating said brazing alloy onto said carbide support;
e) physical vapor depositing said brazing alloy onto said carbide support;
f) chemical vapor depositing said brazing alloy onto said carbide support;
g) spot welding said braze alloy as a braze foil onto said carbide support;
h) brushing said brazing alloy as a paint or paste with a suitable binder material onto said carbide support;
i) adhering said braze alloy in a foil form with an adhesive onto said carbide support;
j) flame spraying said brazing alloy onto said carbide support;
k) hot pressing said braze alloy as a braze foil onto said carbide support;
I) cold pressing said braze alloy as a braze foil onto said carbide support; and
m) dip coating said carbide support in said braze alloy in a molten form.

17. A unit for use in an automated brazing machine to form cutting tools, said unit comprises:
a) a plurality of blanks, each blank comprising a polycrystalline compact bonded to a cemented carbide support, wherein said cemented carbide support is affixed with a brazing alloy;
b) a plurality of inserts, each insert having a pocket for receiving each of said blanks.

18. The unit of claim 17, wherein the cemented carbide support is affixed with a brazing alloy in a form of a slurry, paste, powder, ring, washer, disk, tape, or foil

19. A method for the continuous brazing of tool inserts to form cutting tools, said method comprising the steps of:
a) positioning a blank comprising a polycrystalline compact bonded to a cemented carbide support in a pocket within a tool insert, wherein said cemented carbide support is affixed with a braze alloy;
b) subjecting said blank positioned within said pocketed insert to sufficient heat energy to melt said braze alloy;
c) withdrawing the tool insert having the blank brazed therein;
d) repeating steps a)-c) with each tool insert.

20. The method of claim 19, wherein the cemented carbide support is affixed with a brazing alloy in a form of a slurry, paste, powder, ring, washer, disk, tape, or foil
